(19) United States
(12) Patent Application Publication
(10) Pub. No.: US 2025/0247172 A1
(43) Pub. Date: Jul. 31, 2025

(54) METHOD AND APPARATUS FOR CBG-BASED HARQ-ACK FEEDBACK FOR VARIABLE SIZE DATA TRANSMISSION

(71) Applicant: Lenovo (Beijing) Limited, Beijing (CN)

(72) Inventors: Haipeng Lei, Beijing (CN); Yu Zhang, Beijing (CN); Ruixiang Ma, Beijing (CN); Haiming Wang, Beijing (CN)

(73) Assignee: Lenovo (Beijing) Limited, Beijing (CN)

(21) Appl. No.: 18/854,652

(22) PCT Filed: Apr. 8, 2022
(86) PCT No.: PCT/CN2022/085868

§ 371 Date: Oct. 7, 2024

(51) Int. Cl. H04L 1/1829; H04W 72/232

(52) U.S. Cl. CPC H04L 1/1854; H04L 1/1864; H04W 72/232

(57) ABSTRACT

Embodiments of the present disclosure relate to methods and apparatuses for CBG-based HARQ-ACK feedback. According to some embodiments of the disclosure, a UE may receive a plurality of DCI formats for scheduling a plurality of PDSCH transmissions on one or more carriers associated with the UE, wherein the plurality of DCI formats indicates a same slot for transmitting a slot for transmitting a HARQ-ACK codebook; divide, based on a presence and value of a first indicator in each DCI format, the plurality of DCI formats into two sets; generate a first HARQ-ACK sub-codebook including HARQ-ACK information bits for DCI formats in a first set of the two sets according to DAIs of the DCI formats in the first set; generate a second HARQ-ACK sub-codebook including HARQ-ACK information bits for DCI formats in a second set of the two sets according to DAIs of the DCI formats in the second set; and transmit the HARQ-ACK codebook including the first HARQ-ACK sub-codebook and the second HARQ-ACK sub-codebook.

### TECHNICAL FIELD

Embodiments of the present disclosure generally relate to wireless communication technology, and more particularly to hybrid automatic repeat request acknowledgement (HARQ-ACK) codebook determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). A UE may transmit HARQ-ACK feedback (e.g., included in a HARQ-ACK codebook) corresponding to PDSCH transmissions through a physical uplink control channel (PUCCH) or a physical uplink shared channel (PUSCH).

The industry desires technologies for facilitating HARQ-ACK codebook determination in a communication system.

### SUMMARY

Some embodiments of the present disclosure provide a user equipment (UE). The UE may include a transceiver, and a processor coupled to the transceiver. The processor may be configured to: receive, from a base station (BS), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook; divide, based on a presence and value of a first indicator in each DCI format, the plurality of DCI formats into two sets, wherein a first set of the two sets includes all first type DCI formats of the plurality of DCI formats and a second set of the two sets includes all second type DCI formats of the plurality of DCI formats, wherein downlink assignment indicators (DAIs) of the first type DCI formats are counted separately from those of the second type DCI formats; generate a first HARQ-ACK sub-codebook including HARQ-ACK information bits for DCI formats in the first set according to DAIs of the DCI formats in the first set; generate a second HARQ-ACK sub-codebook including HARQ-ACK information bits for DCI formats in the second set according to DAIs of the DCI formats in the second set; and transmit, to the BS, the HARQ-ACK codebook including the first HARQ-ACK sub-codebook and the second HARQ-ACK sub-codebook.

In some embodiments, the first indicator indicates whether code block group (CBG)-based HARQ-ACK feedback is enabled or disabled.

In some embodiments, the first indicator is indicated by at least one bit in a DCI format of the plurality of DCI formats dedicated for enabling or disabling CBG-based (re)transmission in response to the DCI format including the first indicator. In some embodiments, CBG transmission information (CBGTI) in a DCI format of the plurality of DCI formats is reused as the first indicator in response to the DCI format including the CBGTI.

In some embodiments, the second HARQ-ACK sub-codebook includes: a first part including transport block (TB)-based HARQ-ACK feedback for TBs scheduled by DCI formats in the second set, and a second part including CBG-based HARQ-ACK feedback for TB(s) scheduled by DCI formats in the second set and incorrectly decoded by the UE, wherein each bit of the second part corresponds to CBGs with the same CBG index among the TB(s) scheduled by DCI formats in the second set and incorrectly decoded by the UE.

In some embodiments, the second HARQ-ACK sub-codebook includes: a first part including transport block (TB)-based HARQ-ACK feedback for TBs scheduled by DCI formats in the second set, and a second part including at least one bit field, wherein each of the at least one bit field corresponds to a respective TB of TB(s) scheduled by DCI formats in the second set and incorrectly decoded by the UE.

In some embodiments, in the case that all TBs scheduled by DCI formats in the second set are correctly decoded by the UE, the second HARQ-ACK sub-codebook includes M padding bits, wherein M is the maximum number of CBGs per TB.

In some embodiments, the first indicator indicates the number of code block groups (CBGs) or the number of HARQ-ACK information bits for a TB scheduled by a corresponding DCI.

In some embodiments, each second type DCI format in the second set corresponds to a unified number of HARQ-ACK information bits in the second HARQ-ACK sub-codebook.

In some embodiments, each HARQ-ACK information bit in the first HARQ-ACK sub-codebook corresponds to a respective DCI format in the first set, and every unified number of consecutive HARQ-ACK information bits in the second HARQ-ACK sub-codebook corresponds to a respective DCI format in the second set.

In some embodiments, to generate the second HARQ-ACK sub-codebook, the processor is configured to: generate HARQ-ACK information bits for a DCI format in the second set; and in response to the number of the generated HARQ-ACK information bits for the DCI format being greater than the unified number, perform HARQ-ACK bundling to align the generated HARQ-ACK information bits with the unified number, or in response to the number of the generated HARQ-ACK information bits for the DCI format being less than the unified number, perform HARQ-ACK padding to align the generated HARQ-ACK information bits with the unified number.

In some embodiments, the unified number is configured by the BS, or is determined based on a predefined rule.

Some embodiments of the present disclosure provide a base station (BS). The BS may include a transceiver, and a processor coupled to the transceiver. The processor may be configured to: transmit, to a user equipment (UE), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook; and receive, from the UE, the HARQ-ACK codebook including a first HARQ-ACK sub-codebook and a second HARQ-ACK sub-codebook, wherein the plurality of DCI formats is divided into two sets based on a presence and value of a first indicator in each DCI format, wherein a first set of the two sets includes all first type DCI formats of the plurality of DCI formats and a second set of the two sets includes all second type DCI formats of the plurality of DCI formats, and wherein downlink assignment indicators (DAIs) of the first type DCI formats are counted separately from those of the second type DCI formats; wherein the first HARQ-ACK sub-codebook includes HARQ-ACK information bits for DCI formats in the first set; and wherein the second HARQ-ACK sub-codebook includes HARQ-ACK information bits for DCI formats in the second set.

In some embodiments, the first indicator indicates whether code block group (CBG)-based HARQ-ACK feedback is enabled or disabled.

In some embodiments, the first type DCI format is from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a disabled CBG-based (re)transmission. The second type DCI format is a non-fallback DCI format with the first indicator indicating an enabled CBG-based (re)transmission.

In some embodiments, the first indicator is indicated by at least one bit in a DCI format of the plurality of DCI formats dedicated for enabling or disabling CBG-based (re)transmission in response to the DCI format including the first indicator; or wherein CBG transmission information (CBGTI) in a DCI format of the plurality of DCI formats is reused as the first indicator in response to the DCI format including the CBGTI.

In some embodiments, the second HARQ-ACK sub-codebook includes CBG-based HARQ-ACK information bits with every M consecutive bits corresponding to a respective DCI format in the second set, and M is the maximum number of CBGs per transport block (TB); or wherein the second HARQ-ACK sub-codebook includes a first part including TB-based HARQ-ACK feedback for TBs scheduled by DCI formats in the second set, and a second part including one of the following: CBG-based HARQ-ACK feedback for a first TB among TB(s) scheduled by DCI formats in the second set and incorrectly decoded by the UE; and CBG-based HARQ-ACK feedback for first Z TBs among TB(s) scheduled by DCI formats in the second set and incorrectly decoded by the UE. The processor is configured to transmit a value of Z to the UE; or wherein the value of Z is indicated by at least one of the plurality of DCI formats.

In some embodiments, the second HARQ-ACK sub-codebook includes: a first part including transport block (TB)-based HARQ-ACK feedback for TBs scheduled by DCI formats in the second set, and a second part including CBG-based HARQ-ACK feedback for TB(s) scheduled by DCI formats in the second set and incorrectly decoded by the UE, wherein each bit of the second part corresponds to CBGs with the same CBG index among the TB(s) scheduled by DCI formats in the second set and incorrectly decoded by the UE.

In some embodiments, the second HARQ-ACK sub-codebook includes: a first part including transport block (TB)-based HARQ-ACK feedback for TBs scheduled by DCI formats in the second set, and a second part including at least one bit field, wherein each of the at least one bit field corresponds to a respective TB of TB(s) scheduled by DCI formats in the second set and incorrectly decoded by the UE. In some embodiments, a number of bits for a bit field is based on a maximum number of CBGs per transport block (TB) and a number of TBs scheduled by DCI formats in the second set and incorrectly decoded by the UE.

In some embodiments, in the case that all TBs scheduled by DCI formats in the second set are correctly decoded by the UE, the second HARQ-ACK sub-codebook includes M padding bits, wherein M is the maximum number of CBGs per TB.

In some embodiments, the first indicator indicates the number of code block groups (CBGs) or the number of HARQ-ACK information bits for a TB scheduled by a corresponding DCI.

In some embodiments, the first type DCI format is from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a single CBG per scheduled TB or a single HARQ-ACK information bit per scheduled TB. The second type DCI format is a non-fallback DCI format with the first indicator indicating two or more CBGs per scheduled TB or two or more HARQ-ACK information bits per scheduled TB.

In some embodiments, each second type DCI format in the second set corresponds to a unified number of HARQ-ACK information bits in the second HARQ-ACK sub-codebook.

In some embodiments, each HARQ-ACK information bit in the first HARQ-ACK sub-codebook corresponds to a respective DCI format in the first set, and every unified number of consecutive HARQ-ACK information bits in the second HARQ-ACK sub-codebook corresponds to a respective DCI format in the second set.

In some embodiments, the processor is configured to transmit the unified number to the UE; or the unified number is determined based on a predefined rule.

Some embodiments of the present disclosure provide a method for wireless communication performed by a UE. The method may include: receiving, from a base station (BS), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook; dividing, based on a presence and value of a first indicator in each DCI format, the plurality of DCI formats into two sets, wherein a first set of the two sets includes all first type DCI formats of the plurality of DCI formats and a second set of the two sets includes all second type DCI formats of the plurality of DCI formats, wherein downlink assignment indicators (DAIs) of the first type DCI formats are counted separately from those of the second type DCI formats; generating a first HARQ-ACK sub-codebook including HARQ-ACK information bits for DCI formats in the first set according to DAIs of the DCI formats in the first set; generating a second HARQ-ACK sub-codebook including HARQ-ACK information bits for DCI formats in the second set according to DAIs of the DCI formats in the second set; and transmitting, to the BS, the HARQ-ACK codebook including the first HARQ-ACK sub-codebook and the second HARQ-ACK sub-codebook.

Some embodiments of the present disclosure provide a method for wireless communication performed by a BS. The method may include: transmitting, to a user equipment (UE), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook; and receiving, from the UE, the HARQ-ACK codebook including a first HARQ-ACK sub-codebook and a second HARQ-ACK sub-codebook, wherein the plurality of DCI formats is divided into two sets based on a presence and value of a first indicator in each DCI format, wherein a first set of the two sets includes all first type DCI formats of the plurality of DCI formats and a second set of the two sets includes all second type DCI formats of the plurality of DCI formats, and wherein downlink assignment indicators (DAIs) of the first type DCI formats are counted separately from those of the second type DCI formats; wherein the first HARQ-ACK sub-codebook includes HARQ-ACK information bits for DCI formats in the first set; and wherein the second HARQ-ACK sub-codebook includes HARQ-ACK information bits for DCI formats in the second set.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings.

These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2A illustrates a schematic diagram of a plurality of DCI format scheduling a plurality of transmissions in accordance with some embodiments of the present disclosure;

FIG. 2B illustrates a schematic diagram of HARQ-ACK codebook determination in accordance with some embodiments of the present disclosure;

FIGS. 3 and 4 illustrate a flow chart of an exemplary procedure of wireless communications in accordance with some embodiments of the present disclosure; and

FIG. 5 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

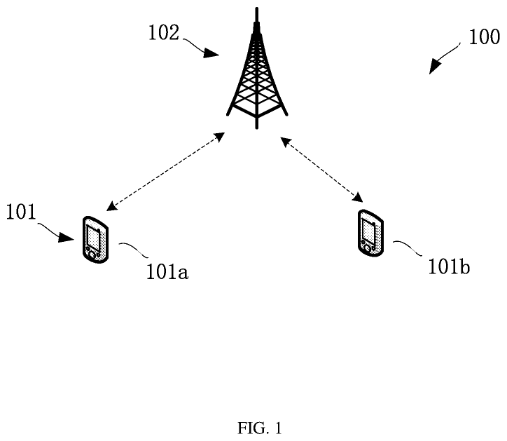

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a wireless communication system may support code block group (CBG)-based (re)transmission besides transport block (TB)-based (re)transmission.

For TB-based (re)transmission, one HARQ-ACK feedback bit may correspond to one TB. As long as one code block (CB) of a TB is not correctly decoded at the receiver (e.g., a UE) side, the whole TB will be reported to as a negative acknowledgement (NACK). As a consequence, the transmitter (e.g., a BS) has to retransmit all the CBs of the TB.

In the case that one HARQ-ACK feedback bit corresponds to one CB, the transmitter (e.g., a BS) thus can know the decoding state of each transmitted CB and may only need to retransmit the failed CBs. In this way, retransmission efficiency can be improved. However, HARQ-ACK feedback overhead may be increased significantly.

In order to balance the number of the needed HARQ-ACK feedback bits and retransmission efficiency, the concept of CBG is introduced. The intention of a CBG is to group several code blocks into one code block group and the resulting HARQ-ACK feedback is generated per CBG. Only all the code blocks within one CBG are correctly decoded, the HARQ-ACK feedback for the CBG can be set to an acknowledgement (ACK); otherwise, it is set to “NACK”. In response to the reception of the HARQ-ACK feedback, the transmitter may only retransmit the CBG(s) reported as “NACK”.

In some embodiments of the present disclosure, for CBG-based (re)transmission, RRC signaling may be used to configure the maximum number of CBGs per TB. In some examples, the maximum number of CBGs per TB may be 2, 4, 6 and 8. For both a semi-static HARQ-ACK codebook and a dynamic HARQ-ACK codebook, the number of HARQ-ACK information bits for one TB may be equal to the configured maximum number of CBGs per TB, regardless of the variable TB size (TBS) of a specific TB. For example, HARQ-ACK padding may be performed to align the actual HARQ-ACK information bits with the configured maximum number.

Certain traffic (e.g., extended reality (XR) traffic) in a wireless communication system may have a variable data packet size. For example, sometimes the XR traffic is generated with a larger data packet size, and sometimes with a small data packet size. For the large packet size, CBG-based (re)transmission is quite appropriate since the BS can only retransmit those CBGs not incorrectly decoded, instead of all the code blocks of the whole TB.

However, since the maximum number of CBGs per TB is configured by RRC signaling, the number of CBG-level HARQ-ACK information bits for a scheduled TB may always be equal to the RRC configured maximum number, regardless whether a small or large size of the scheduled TB. For example, in the case of a small TB size, even if a TB scheduled by a DCI includes a few code blocks, the UE has to generate the CBG-level HARQ-ACK information bits for the TB, and add padding bits (e.g., NACK bits) until the number of bits after padding is equal to the RRC configured maximum number. Thus, unnecessary signaling overhead is caused, which would impact UE transmit power consumption and the UL coverage.

Embodiments of the present disclosure provide solutions for CBG-based HARQ-ACK feedback corresponding to traffic (e.g., XR traffic) with a variable data packet size. For example, solutions for dynamic CBG-based (re)transmission configuration are proposed. Solutions for HARQ-ACK codebook determination are also proposed. These solutions can solve the above-mentioned issues including, for example, reducing unnecessary signaling overhead. More details on the embodiments of the present disclosure will be illustrated in the following text in combination with the appended drawings.

In some embodiments of the present disclosure, for a carrier where CBG-based (re)transmission is configured, an indicator indicating whether CBG-based HARQ-ACK feedback is enabled or disabled (i.e., TB-based HARQ-ACK feedback is enabled) may be included in a non-fallback DCI format (e.g., DCI format 1_1 or DCI format 1_2). This indicator may indicate whether TB-based HARQ-ACK feedback or CBG-based HARQ-ACK feedback is enabled for the PDSCH scheduled by the DCI format. In some examples, the indicator may be referred to as a CBG-based HARQ-ACK feedback enabling/disabling indicator (CBGEI). In some examples, the indicator may be referred to as a TB-based HARQ-ACK feedback enabling/disabling indicator (TBEI). For simplicity, the above indicator in the DCI format is referred to as “CBGEI” hereinafter. It should be appreciated that the descriptions regarding the “CBGEI” in the context of the present disclosure can also be applied to the “TBEI” or any other terms that the indicator may be referred to.

It is assumed that M is the maximum number of CBGs per TB configured by RRC signaling. In the case of a TB with a small TBS scheduled by a DCI format, a BS can indicate to a UE that CBG-based HARQ-ACK feedback is disabled and TB-based HARQ-ACK feedback is used, so that only a single HARQ-ACK information bit for this TB is sufficient, which can reduce HARQ-ACK feedback overhead from M bits to 1 bit. In the case of a TB with a large TBS scheduled by a DCI format, a BS can indicate a UE that CBG-based HARQ-ACK feedback is enabled, so that M CBG-based HARQ-ACK information bits are to be reported for the TB. This can improve retransmission efficiency when a few CBGs of the TB are reported as NACK.

For a specific TB, the setting of the CBGEI should be kept consistent between an initial transmission and a possible subsequent retransmission(s). That is, the same CBGEI is indicated in a DCI format scheduling the TB in an initial transmission and in a DCI format(s) scheduling the TB in retransmission(s). The UE does not expect different HARQ-ACK feedback options indicated for the initial transmission and retransmissions of the same TB.

Various methods may be employed to indicate the CBGEI in a DCI format.

In some embodiments, at least one bit in a DCI format may indicate the CBGEI. That is, the at least one bit is dedicated for indicating enabling or disabling a CBG-based (re)transmission. For example, bit “1” may indicate enabled CBG-based HARQ-ACK feedback and bit “0” may indicate disabled CBG-based HARQ-ACK feedback; or vice versa. For a given TB, the value of the bit should be kept consistent between an initial transmission and subsequent retransmission(s), i.e., the same value of the bit should be indicated in a DCI format scheduling the TB in an initial transmission and in a DCI format(s) scheduling the TB in retransmission(s).

In some embodiments, the CBG transmission information (CBGTI) in a DCI format may be reused as the CBGEI. For example, in the case that the CBGTI is set to all “1”s in a DCI format scheduling an initial transmission of a TB as indicated by the new data indicator (NDI) field of the scheduling DCI, a UE may assume that CBG-based HARQ-ACK feedback is enabled. In the case that the CBGTI is set to all “0”s in a DCI format scheduling an initial transmission of a TB as indicated by the NDI field of the scheduling DCI, the UE may assume that CBG-based HARQ-ACK feedback is disabled. For a retransmission of a TB as indicated by the NDI field of the scheduling DCI, the UE may assume that the CBGTI field of the scheduling DCI indicates which CBGs of the TB are present in the transmission. A bit value of “0” in the CBGTI field may indicate that the corresponding CBG is not transmitted and “1” may indicate that the corresponding CBG is transmitted. For a given TB, as long as CBG-based HARQ-CK feedback is enabled by a DCI format scheduling the TB in an initial transmission, the UE assumes that the CBG-based HARQ-ACK feedback is adopted in any subsequent retransmission(s) of the TB; otherwise, when the CBG-based HARQ-CK feedback is disabled by a DCI format scheduling the TB in an initial transmission, the UE assumes that the TB-based HARQ-ACK feedback is adopted in any subsequent retransmission(s) of the TB.

A fallback DCI format (e.g., DCI format 1_0) may not include such CBGEI as only TB-level HARQ-ACK feedback is used for the scheduled PDSCH. For a carrier where CBG-based (re)transmission is not configured, the CBGEI is not included in any DCI format for scheduling a PDSCH on this carrier. A DCI format may be transmitted without scheduling a PDSCH, e.g., used for indicating DL SPS release or SCell dormancy, a single bit HARQ-ACK feedback is required for the DCI format, where the CBGEI is not included in the DCI format.

In some embodiments of the present disclosure, HARQ-ACK codebook construction may be dependent on the types of the DCI and/or the enabled or disabled CBGEI.

For example, DCI type #1 is defined as a DCI format which requires a single HARQ-ACK information bit. DCI type #1 can include, for example, the below DCI formats:
a fallback DCI format, for example, DCI format 1_0 for dynamic PDSCH scheduling, semi-persistent scheduling (SPS) PDSCH release or SCell dormancy, no matter the fallback DCI format is transmitted on a carrier configured with CBG-based transmission or not;
a non-fallback DCI format (e.g., DCI format 1_1 or DCI format 1_2) which is transmitted on a carrier not configured with CBG-based (re)transmission;
a non-fallback DCI format without the presence of the CBGEI; and
a non-fallback DCI format (e.g., DCI format 1_1 or DCI format 1_2) with a CBGEI indicating a disabled CBG-based (re)transmission (for example, transmitted on a carrier configured with CBG-based (re)transmission and with disabled CBGEI).

DCI type #2 is defined as a DCI format which requires two or more HARQ-ACK information bits. DCI type #2 can include, for example, below DCI formats:
a non-fallback DCIs format (e.g., DCI format 1_1 or DCI format 1_2) with a CBGEI indicating an enabled CBG-based (re)transmission (for example, transmitted on a carrier configured with CBG-based (re)transmission and with enabled CBGEI).

DCI formats which schedule the same slot for transmitting HARQ-ACK feedback may be divided into two sets according to the DCI types (e.g., DCI type #1 and DCI type #2). For example, set #1 may include all the DCI formats of DCI type #1 (hereinafter, “type #1 DCI format” for clarity) and set #2 may include all the DCI formats of DCI type #2 (hereinafter, “type #2 DCI format” for clarity).

DAIs may be counted independently (separately) for type #1 DCI format and type #2 DCI format. Accordingly, DAIs may be counted separately in the two sets. The number of transmitted type #1 DCI formats and the number of transmitted type #2 DCI formats may be separately determined based on the respective total DAIs in the carrier aggregation (CA) case or respective counter DAIs in the single carrier case.

A UE may generate separate HARQ-ACK sub-codebooks for the two sets, which may be included in a final HARQ-ACK codebook for transmitting on the scheduled slot to the BS. For example, the HARQ-ACK codebook may include HARQ-ACK sub-codebook #1 including HARQ-ACK information bits for DCI formats in set #1 and HARQ-ACK sub-codebook #2 including HARQ-ACK information bits for DCI formats in set #2. HARQ-ACK sub-codebooks #1 and #2 may be arranged according to a predefined order in the HARQ-ACK codebook. For example, HARQ-ACK sub-codebook #1 may be placed in front of HARQ-ACK sub-codebook #2.

In HARQ-ACK sub-codebook #1, the HARQ-ACK information bits may be ordered according to the DAIs (e.g., counter DAIs) of DCI formats in set #1 (e.g., an ascending or descending order of the DAIs). Each HARQ-ACK information bit in HARQ-ACK sub-codebook #1 may correspond to a respective DCI format in set #1. For example, a HARQ-ACK information bit in HARQ-ACK sub-codebook #1 may be a single HARQ-ACK information bit for a PDSCH scheduled by a corresponding type #1 DCI format, or a single HARQ-ACK information bit for a corresponding type #1 DCI format which indicates SPS release or SCell dormancy. HARQ-ACK feedback for SPS PDSCH may be also included in HARQ-ACK sub-codebook #1 since a single HARQ-ACK information bit is generated for an SPS PDSCH. HARQ-ACK feedback for SPS PDSCH may be placed in a predefined position of HARQ-ACK sub-codebook #1, e.g., the beginning or the end of HARQ-ACK sub-codebook #1.

Various methods may be applied to generate the HARQ-ACK information bits in HARQ-ACK sub-codebook #2. For simplicity, M denotes the maximum number of CBGs per TB configured by RRC signaling. It is assumed that assume N TBs are scheduled by N respective type #2 DCI formats in set #2.

In some embodiments, HARQ-ACK sub-codebook #2 may include the CBG-based HARQ-ACK information bits with every M consecutive bits corresponding to a respective type #2 DCI format and ordered based on the DAIs (e.g., counter DAI) among the DCI formats in set #2. The HARQ-ACK sub-codebook #2 may thus include NxM bits, where every M bits correspond to a respective one of the N TBs. For a specific TB, if the number of code block groups of this TB is smaller than M, padding bits (e.g., “NACK” bits) may be added (appended) to align the CBG-based HARQ-ACK information bits for the code block groups of the TB (e.g., generated based on the decoding status) with M bits.

In some embodiments, HARQ-ACK sub-codebook #2 may include two parts (denoted as “part #1” and “part #2” for clarity). Part #1 and part #2 may be arranged according to a predefined order in HARQ-ACK sub-codebook #2. For example, part #1 may be placed in front of part #2. Part #1 may include TB-based HARQ-ACK feedback for the N TBs scheduled by the DCI formats in set #2. Part #1 of HARQ-ACK sub-codebook #2 may thus include N bits. The TB-based HARQ-ACK information bits in part #1 may be ordered based on the DAIs (e.g., counter DAI) among the DCI formats in set #2.

Various methods may be applied to generate part #2 of HARQ-ACK sub-codebook #2.

In some examples, part #2 may include CBG-based HARQ-ACK feedback for the first TB (denoted as “TB #A1” for clarity) among the N TBs which is incorrectly decoded (e.g., reported as NACK in part #1). Part #2 may thus include M CBG-based HARQ-ACK information bits for TB #A1. Each of the M bits in part #2 may correspond to a respective CBG of TB #A1. In the case that all the N TBs are correctly decoded (e.g., reported as N ACKs in part #1), part #2 can be padded with M padding bits (e.g., M “NACK” bits). If the number of code block groups of TB #A1 (denoted as “O” for clarity) is smaller than M (e.g., O<M), (M-O) padding bits may be added (appended) to align the generated O CBG-based HARQ-ACK information bits for the O code block groups of TB #A1 with M bits. Therefore, HARQ-ACK sub-codebook #2 may include N+M bits (N bits for part #1 as described above and M bits for part #2).

In some examples, part #2 may include CBG-based HARQ-ACK feedback for the TB(s) among the N TBs which is incorrectly decoded (e.g., reported as NACK in part #1). Each bit in part #2 may correspond to CBGs with the same CBG index among the TB(s) incorrectly decoded, and may be generated by performing HARQ-ACK bundling (e.g., logic AND operation) among the generated CBG-level HARQ-ACK information bits for CBGs with the corresponding CBG index among all the TB(s) incorrectly decoded.

For example, assuming that K is the number of TBs which are not correctly decoded (e.g., reported as NACK in part #1), 0<=K<=N, then there are K NACK (or discrete transmission (DTX)) bit(s) included in part #1. Part #2 may include M bundled CBG-level HARQ-ACK information bits. Various methods may be employed to obtain the bundled CBG-level HARQ-ACK information bits.

For example, the first bit in part #2 may be generated by performing a logic AND operation among all the CBG₀s (e.g., CBG with CBG index of 0) of the K incorrectly decoded TBs; the second bit in part #2 may be generated by performing a logic AND operation among all the CBG₁s of the K incorrectly decoded TBs; . . . ; and the M^{th} bit in part #2 may be generated by performing a logic AND operation among all the CBG_{M-1}s of the K incorrectly decoded TBs. For a specific TB, when the number of code block groups of the TB is smaller than M, then before the above-mentioned CBG-level HARQ-ACK bundling, ACK bits may be added (e.g., appended) to align the CBG-based HARQ-ACK information bits for the code block groups of this TB with M bits. For example, for a given TB, when the number of code block groups of this TB is smaller than M, then before CBG-level HARQ-ACK bundling, (M-O′) ACK bits are appended for CBG_{O′}, CBG_{O′+1}, . . . , CBG_{M-1}, where O′ is the number of code blocks of the TB and O′<M.

In another example, assuming that S is the largest CBG index among the CBGs of the K incorrectly decoded TBs and 0<=S<=M−1, the first S+1 bits in part #2 may be generated by performing a logic AND operation among all the CBG₀s of the K incorrectly decoded TBs, all the CBGis of the K incorrectly decoded TBs, . . . , all the CBG_{S}s of the K incorrectly decoded TBs, respectively. In the case that S<M−1, padding bits (e.g., “NACK” bits) may be added (appended) to align the S+1 bundled bits with M bits.

Therefore, HARQ-ACK sub-codebook #2 may include N+M bits, where part #1 includes N TB-based HARQ-ACK information bits and part #2 includes M bundled CBG-based HARQ-ACK information bits for all the TB(s) which is incorrectly decoded (e.g., reported as NACK in part #1). In the case that all the N TBs are correctly decoded (e.g., reported as N ACKs in part #1), part #2 can be padded with M padding bits (e.g., M “NACK” bits).

In some examples, part #2 may include CBG-based HARQ-ACK feedback for the TB(s) among the N TBs which is incorrectly decoded (e.g., reported as NACK in part #1). The construction of part #2 may be dependent on the number of TBs which are incorrectly decoded (e.g., reported as NACK in part #1).

Still assuming that K is the number of TBs which are not correctly decoded (e.g., reported as NACK in part #1), 0<=K<=N, then there are K NACK (or DTX) bit(s) included in part #1. When K=0, part #2 may include M padding bits (e.g., NACK bits). When K>0, part #2 may include K bit fields with each bit field corresponding to a respective one of the K incorrectly decoded TBs. The number of bits for a bit field may be based on the maximum number of CBGs TB (e.g., M) and K. For example, the size of the bit field may be equal to M/K.

Each bit field may be generated by performing HARQ-ACK bundling (e.g., logic AND operation) among CBG-based HARQ-ACK information bits for a corresponding one of the K incorrectly decoded TBs. For example, HARQ-ACK bundling may be performed on every K consecutive CBGs of the corresponding TB to obtain M/K bits.

For instance, when K=1, part #2 may include one bit field, i.e., M CBG-based HARQ-ACK information bits for the single incorrectly decoded TB. Each bit of the M bits may correspond to a respective one CBG of this TB. If the number of code block groups of this single TB is smaller than M, padding bits may be added (appended) to align with M bits. In this scenario, since the CBG-level HARQ-ACK information bits for the single TB is not greater than the size of the bit field, no HARQ-ACK bundling is needed; otherwise, as will be described in the following text, HARQ-ACK bundling may be performed to align with the size of the bit field.

For instance, when K=2, part #2 may include two bit fields, i.e., the first M/2 bits corresponding to the first incorrectly decoded TB (denoted as “TB #B1” for clarity) and the second M/2 bits corresponding to the second incorrectly decoded TB (denoted as “TB #B2” for clarity). Each bit of the first M/2 bits may be generated by performing HARQ-ACK bundling (e.g., logic AND operation) among CBG-based HARQ-ACK information bits for TB #B1. For example, CBG-based HARQ-ACK information bits of every two consecutive CBGs of TB #B1 may be bundled to one bit. When the number of code block groups of TB #B1 is smaller than M, then before the above-mentioned CBG-level HARQ-ACK bundling, ACK bits may be added (e.g., appended) to align the CBG-based HARQ-ACK information bits for TB #B1 with M bits. Similar operations may be applied to obtain the second M/2 bits in part #2.

Therefore, HARQ-ACK sub-codebook #2 may include N+M bits, where part #1 includes N TB-based HARQ-ACK information bits and part #2 includes M bundled CBG-based HARQ-ACK information bits for all the TB(s) which is incorrectly decoded (e.g., reported as NACK in part #1). In the case that all the N TBs are correctly decoded (e.g., reported as N ACKs in part #1), part #2 can be padded with M padding bits (e.g., M “NACK” bits).

In some examples, part #2 may include CBG-based HARQ-ACK feedback for the first Z TBs among the N TBs which are incorrectly decoded (e.g., reported as NACK in part #1). Part #2 may thus include ZxM CBG-based HARQ-ACK information bits with every M bits corresponding to a respective one of the Z incorrectly decoded TBs. Therefore, HARQ-ACK sub-codebook #2 may include N+Z×M bits (N bits for part #1 as described above).

In some examples, the value of Z may be configured by a BS via, for example, RRC signaling. For example, the BS may configure the value of Z from a set of possible values (e.g., {1, 2, 3, or 4}. The set of possible values may be configured by the BS via, for example, RRC signaling, or predefined, for example, in a standard(s). In some examples, the value of Z may be dynamically indicated by a DCI format. For example, at least one of the DCI formats scheduling the N TBs may indicate a value from the set of possible values. The size of such indicator may be dependent on the number of values in the set of possible values. For example, for the set of {1, 2, 3, or 4}, 2 bits (log₂ 4) would be enough.

Still assuming that K is the number of TBs which are not correctly decoded (e.g., reported as NACK in part #1), 0<=K<=N, when K<Z, then (Z−K)×M bits are added (e.g., appended) in part #2 to align with the size of Z×M. When K=Z, every M consecutive CBG-based HARQ-ACK information bits in part #2 correspond to a respective one of the K incorrectly decoded TBs. When K>Z, only the first Z TBs of the K incorrectly decoded TBs have corresponding CBG-based HARQ-ACK information bits in part #2. For a specific TB, if the number of code block groups of this TB is smaller than M, padding bits (e.g., “NACK” bits) may be added (appended) to align the CBG-based HARQ-ACK information bits for this TB with M bits.

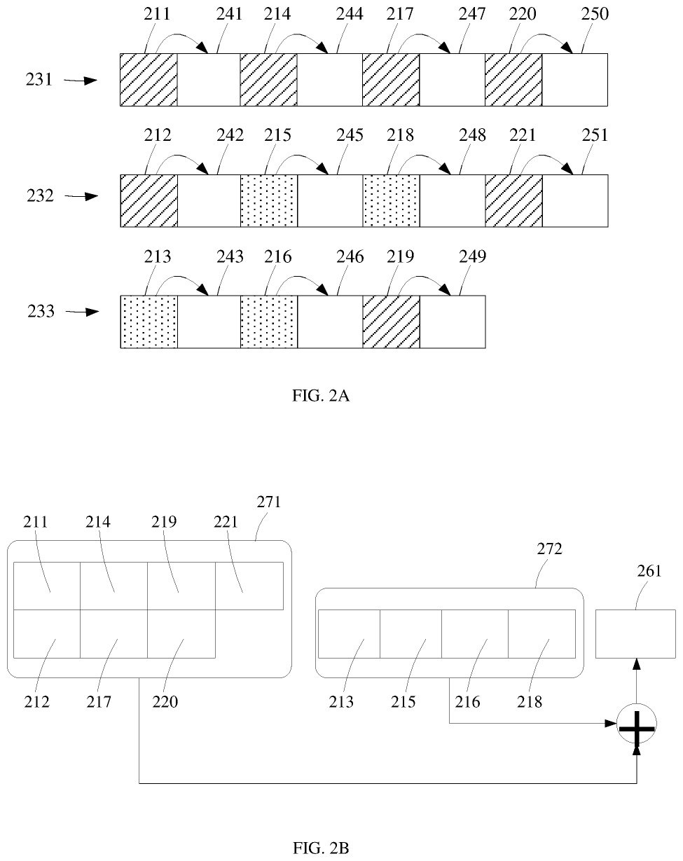

FIG. 2A illustrates a schematic diagram of a plurality of DCI format scheduling a plurality of transmissions in accordance with some embodiments of the present disclosure. FIG. 2B illustrates a schematic diagram of HARQ-ACK codebook determination for the plurality of scheduled transmissions in FIG. 2A in accordance with some embodiments of the present disclosure.

In FIG. 2A, a plurality of CCs (e.g., including but not limited to CCs 231-233 in FIG. 2A) may be configured for a UE. It should be understood that the sub-carrier spacings (SCSs) of the carriers configured for a UE may be the same or different. Each of the plurality of CCs may correspond to a respective serving cell of the UE. Each serving cell may be associated with a serving cell index.

As shown in FIG. 2A, a BS may transmit to the UE DCI formats 211, 214, 217, and 220 on CC 231 to schedule PDSCHs 241, 244, 247, and 250, respectively. The BS may transmit to the UE DCI formats 212, 215, 218, and 221 on CC 232 to schedule PDSCHs 242, 245, 248, and 251, respectively. The BS may transmit to the UE DCI formats 213, 216, and 219 on CC 233 to schedule PDSCHs 243, 246, and 249, respectively. DCI formats 211-220 may be non-fallback DCI formats (e.g., DCI format 1_1 or DCI format 1_2) and DCI format 221 may be a fallback DCI format (e.g., DCI format 1_0). In some examples, DCI formats 211-221 may schedule the same slot for transmitting HARQ-ACK feedback.

In some embodiments of the present disclosure, assuming that CC 232 and CC 233 are configured with CBG-based (re)transmission and CC 231 is not configured with CBG-based (re)transmission, any DCI formats on CC 231 and any fallback DCI format on any of the configured CCs (e.g., CCs 231-233) may not include an CBGEI. For example, since DCI format 221 is a fallback DCI format, DCI format 221 does not indicate the CBGEI. Since CC 231 is not configured with CBG-based (re)transmission, DCI formats 211, 214, 217, and 220 do not indicate the CBGEI.

It is further assumed that DCI formats 213, 215, 216 and 218 indicate an enabled CBGEI and DCI formats 212 and 219 indicate a disabled CBGEI. DCI formats 211-221 are divided into two sets (e.g., set #A1 and set #A2). According to the above descriptions with respect to type #1 DCI format and type #2 DCI format and set #1 and set #2, set #A1 includes seven type #1 DCI formats, that is, DCI formats 211, 214, 217, and 220 on CC 231, one fall DCI format (i.e., DCI format 221) on CC 232, and two DCI formats with disabled CBGEI (i.e., DCI format 212 and DCI format 219) on CC 232 and CC 233. Set #A2 includes four type #2 DCI formats, that is, two DCI formats with enabled CBGEI (i.e., DCI format 215 and DCI format 218) on CC 232 and another two DCI formats with enabled CBGEI (i.e., DCI format 213 and DCI format 216) on CC 233.

Counter DAI and total DAI are separately counted within each set. For example, {counter DAI, total DAI} of DCI formats 211-221 may indicate {1, 2}, {2, 2}, {1, 1}, {3, 3}, {2, 3}, {3, 3}, {4, 5}, {4, 4}, {5, 5}, {6, 7}, {7, 7}, respectively.

Referring to FIG. 2B, two HARQ-ACK sub-codebooks (e.g., sub-codebooks 271 and 272) may be generated for set #A1 and set #A2, respectively.

Sub-codebooks 271 and 272 may be arranged according to a predefined order in a HARQ-ACK codebook, which may be transmitted on PUCCH 261.

Sub-codebook 271 includes HARQ-ACK information bits for DCI formats in set #A1. For example, as shown in FIG. 2B, sub-codebook 271 may include seven HARQ-ACK information bits, each of which corresponds to a respective DCI format of set #A1 (i.e., DCI formats 211, 212, 214, 217, 219, 220, and 221). The seven HARQ-ACK information bits may be ordered according to the counter DAIs of DCI formats 211, 212, 214, 217, 219, 220, and 221.

Sub-codebook 272 includes HARQ-ACK information bits for DCI formats (e.g., DCI formats 213, 215, 216 and 218) in set #A2. Various methods described above for generating the HARQ-ACK information bits in HARQ-ACK sub-codebook #2 may apply here. For simplicity, it is assumed that the maximum number of CBGs per TB configured by RRC signaling (e.g., M) is equal to 8.

In some embodiments, sub-codebook 272 includes 4×8=32 CBG-based HARQ-ACK information bits with every 8 consecutive bits corresponding to the TB scheduled by a respective one of the four type #2 DCI formats in set #A2.

In some embodiments, sub-codebook 272 includes two parts (e.g., part #A1 and part #A2). Various methods described above for determining part #1 and part #2 may apply here. For example, part #A1 includes 4 TB-based HARQ-ACK information bits for the four TBs scheduled by the four type #2 DCI formats in set #A2.

In some embodiments, part #A2 includes 8 CBG-based HARQ-ACK information bits for the first TB which is incorrectly decoded in part #A1. Assuming that part #A1 includes {a0, a1, a2, a3} ordered based on an ascending order of the counter DAIs of the DCI formats in set #A2, when a1 is the first NACK in the set {a0, a1, a2, a3}, this implies that the TB scheduled by DCI format 215 is not correctly decoded. Part #A2 thus may include 8 CBG-based HARQ-ACK information bits with each bit corresponding to a respective one CBG of the TB scheduled by DCI format 215.

In some embodiments, part #A2 includes 8 CBG-based HARQ-ACK information bits for the incorrectly decoded TBs among the scheduled four TBs. Also assuming that part #A1 includes {a0, a1, a2, a3} ordered based on an ascending order of the counter DAIs of the DCI formats in set #A2, when both a1 and a2 are a NACK bit in the set {a0, a1, a2, a3}, this implies the two TBs scheduled by DCI format 215 and DCI format 216 are not correctly decoded.

The UE may generate CBG-based HARQ-ACK information bits for the two incorrectly decoded TBs, based on the corresponding decoding statuses. The UE may then bundle the two CBG-based HARQ-ACK information bits for CBG₀ of the two incorrectly decoded TBs to a single bundled bit. Similarly, the UE may bundle the two CBG-based HARQ-ACK information bits for CBG₁ of the two incorrectly decoded TBs to a bundled single bit. The UE may perform such operation repeatedly until all of the CBG-based HARQ-ACK information bits of the two incorrectly decoded TBs are processed (e.g., the two CBG-based HARQ-ACK information bits for CBG₇ (if any) of the two TBs are bundled to a single bit). In the case that the number of bundled bits is less than 8, the UE may add a padding bit(s) to align with 8 bits. In this way, part #A2 includes 8 CBG-based HARQ-ACK information bits.

In some embodiments, part #A2 includes 8 CBG-based HARQ-ACK information bits for the incorrectly decoded TBs among the scheduled four TBs. Still assuming that part #A1 includes {a0, a1, a2, a3} ordered based on an ascending order of the counter DAIs of the DCI formats in set #A2, when none of a0-a3 is a NACK bit, part #A2 includes 8 padding bits. When only one (e.g., a1) of a0-a3 is a NACK bit, this implies that the TB scheduled by a corresponding DCI format (e.g., DCI format 215) is not correctly decoded. Part #A2 may include 8 CBG-based HARQ-ACK information bits with each bit corresponding to a respective CBG of the TB scheduled by DCI format 215.

When two (e.g., a1 and a2) of a0-a3 are a NACK bit, this implies that the two TBs scheduled by the corresponding DCI formats (e.g., DCI format 215 and DCI format 216) are not correctly decoded. Part #A2 may include two bit fields corresponding to DCI format 215 and DCI format 216. Denoting CBG-based HARQ-ACK information bits in part #A2 as {b0, b1, b2, b3, b4, b5, b6, b7}, the first 4 bits ({b0, b1, b2, b3}) correspond to CBG-based HARQ-ACK information bits for the TB scheduled by DCI format 215, wherein b0 may be a bundled bit of the CBG-based HARQ-ACK information bits for CBG₀ and CBG₁ of the TB scheduled by DCI format 215; b1 may be a bundled bit of the CBG-based HARQ-ACK information bits for CBG₂ and CBG₃ of the TB scheduled by DCI format 215; b2 may be a bundled bit of the CBG-based HARQ-ACK information bits for CBG₄ and CBG₅ of the TB scheduled by DCI format 215; and b3 may be a bundled bit of the CBG-based HARQ-ACK information bits for CBG₆ and CBG₇ of the TB scheduled by DCI format 215. The last 4 bits ({b4, b5, b6, b7}) in part #A2 correspond to CBG-based HARQ-ACK information bits for the TB scheduled by DCI format 216, wherein b4 may be a bundled bit of the CBG-based HARQ-ACK information bits for CBG₀ and CBG₁ of the TB scheduled by DCI format 216; b5 may be a bundled bit of the CBG-based HARQ-ACK information bits for CBG₂ and CBG₃ of the TB scheduled by DCI format 216; b6 may be a bundled bit of the CBG-based HARQ-ACK information bits for CBG₄ and CBG₅ of the TB scheduled by DCI format 216; and b7 may be a bundled bit of the CBG-based HARQ-ACK information bits for CBG₆ and CBG₇ of the TB scheduled by DCI format 216.

In some examples, part #2 includes Z×8 CBG-based HARQ-ACK information bits for the first Z TBs which are incorrectly decoded in part #A1.

Assuming that the value of Z is 2, which may be configured by RRC signaling or indicated by a DCI format as described above, and still assuming that part #A1 includes {a0, a1, a2, a3} ordered based on an ascending order of the counter DAIs of the DCI formats in set #A2, when none of a0-a3 is a NACK bit, part #A2 includes 2×8 padding bits. When only one (e.g., a1) of a0-a3 is a NACK bit, this implies that the TB scheduled by a corresponding DCI format (e.g., DCI format 215) is not correctly decoded. Part #A2 may include 2×8 CBG-based HARQ-ACK information bits, wherein the first (or the last) 8 bits may be CBG-based HARQ-ACK information bits for DCI format 215 and the last (or the first) 8 bits may be padding bits. For example, each of the first 8 bits in part #A2 may correspond to a respective one CBG of the TB scheduled by DCI format 215.

When two (e.g., a1 and a2) of a0-a3 are a NACK bit, this implies that the two TBs scheduled by the corresponding DCI formats (e.g., DCI format 215 and DCI format 216) are not correctly decoded. Part #A2 may include 2×8 CBG-based HARQ-ACK information bits, wherein the first (or the last) 8 bits may be CBG-based HARQ-ACK information bits for DCI format 215 and the last (or the first) 8 bits may be CBG-based HARQ-ACK information bits for DCI format 216. For example, each of the first 8 bits in part #A2 may correspond to a respective one CBG of the TB scheduled by DCI format 215. Each of the last 8 bits in part #A2 may correspond to a respective one CBG of the TB scheduled by DCI format 216.

When more than two (e.g., a1, a2, and a3) of a0-a3 are a NACK bit, this implies that the three TBs scheduled by the corresponding DCI formats (e.g., DCI formats 215, 216, and 218) are not correctly decoded. Part #A2 may include 2×8 bits for the first two incorrectly decoded TBs. For example, the first 8 bits may be CBG-based HARQ-ACK information bits for DCI format 215 and the last 8 bits may be CBG-based HARQ-ACK information bits for DCI format 216. Each of the first 8 bits in part #A2 may correspond to a respective one CBG of the TB scheduled by DCI format 215. Each of the last 8 bits in part #A2 may correspond to a respective one CBG of the TB scheduled by DCI format 216.

In some embodiments of the present disclosure, for a carrier where CBG-based (re)transmission is configured, an indicator may be included in a non-fallback DCI format (e.g., DCI format 1_1 or DCI format 1_2) to indicate the number of CBGs for the TB scheduled by the DCI format.

In some examples, the indicator may indicate a value from a set of possible CBG numbers for a TB. The set of possible CBG numbers may be configured by the BS via, for example, RRC signaling, or predefined, for example, in a standard(s). The size of the indicator may thus dependent on the number of values in the set of possible CBG numbers. For example, for a set of {1, 2, 4, 8}, 2 bits (log₂ 4) would be enough. In another example, the set of possible CBG numbers may include 8 values (e.g., 11, 2, 4, 6, 8, 10, 12, 161) with values larger than 8 used for a larger TBS. In this example, the indicator may include at least 3 bits (log₂ 8).

When the value of 1 is indicated, the UE assumes that the scheduled TB includes a single CBG and shall generate one HARQ-ACK information bit for the scheduled TB, which is similar to TB-based HARQ-ACK feedback. When the value of 2, 4 or 8 is indicated, the UE assumes that the scheduled TB includes 2, 4 or 8 CBGs and shall generate 2, 4, or 8 HARQ-ACK information bits for the scheduled TB, which is similar to CBG-based HARQ-ACK feedback.

Alternatively, this indicator in the DCI format may directly indicate the number of HARQ-ACK information bits for the TB scheduled by the DCI format.

In this way, a BS can dynamically control the number of required HARQ-ACK information bits for the scheduled TB to reach a tradeoff between retransmission efficiency and HARQ-ACK feedback overhead.

For a specific TB, the indicated number of CBGs or the indicated number of HARQ-ACK information bits for the scheduled TB should keep consistent between an initial transmission and a possible subsequent retransmission(s). That is, the same number of CBGs or the same number of HARQ-ACK information bits is indicated in a DCI format scheduling the TB in an initial transmission and in a DCI format(s) scheduling the TB in retransmission(s). The UE does not expect different numbers of CBGs for the TB or different numbers of HARQ-ACK information bits indicated for the initial transmission and retransmissions of the same TB. The CBG construction of a TB is not changed between the initial transmission and retransmission(s).

A fallback DCI format (e.g., DCI format 1_0) may not include such indicator as only TB-level HARQ-ACK feedback is used for the scheduled PDSCH. For a carrier where CBG-based (re)transmission is not configured, such indicator is not included in any DCI format for scheduling a PDSCH on this carrier.

In some embodiments of the present disclosure, HARQ-ACK codebook construction may be dependent on the number of CBGs per TB or the number of required HARQ-ACK information bits per TB. Several DCI types are defined according to the number of CBGs per TB or the number of required HARQ-ACK information bits per TB.

For example, DCI type #1′ is defined as a DCI format which requires a single HARQ-ACK information bit. DCI type #1′ can include, for example, the below DCI formats:
a fallback DCI format, for example, DCI format 1_0 for dynamic PDSCH scheduling, SPS PDSCH release or SCell dormancy, no matter whether the fallback DCI format is transmitted on a carrier configured with CBG-based transmission or not;
a non-fallback DCI format (e.g., DCI format 1_1 or DCI format 1_2) which is transmitted on a carrier not configured with CBG-based (re)transmission;
a non-fallback DCI format without the presence of the indicator; and
a non-fallback DCI format (e.g., DCI format 1_1 or DCI format 1_2) with the indicator indicating a single CBG per scheduled TB or a single HARQ-ACK information bit per scheduled TB (for example, transmitted on a carrier configured with CBG-based (re)transmission and indicating a single CBG or a single HARQ-ACK information bit per scheduled TB).

DCI type #2′ is defined as a DCI format which requires two or more HARQ-ACK information bits. DCI type #2′ can include, for example, the below DCI format:
a non-fallback DCI format (e.g., DCI format 1_1 or DCI format 1_2) with the indicator indicating two or more CBGs per scheduled TB or two or more HARQ-ACK information bits per scheduled TB (for example, transmitted on a carrier configured with CBG-based (re)transmission and indicating two or more CBGs or HARQ-ACK information bits per scheduled TB).

DCI formats which schedule the same slot for transmitting HARQ-ACK feedback may be divided into two sets according to the DCI types (e.g., DCI type #1′ and DCI type #2′). For example, set #1′ may include all the DCI formats of DCI type #1′ (hereinafter, “type #1′ DCI format” for clarity) and set #2′ may include all the DCI formats of DCI type #2′ (hereinafter, “type #2′ DCI format” for clarity).

DAIs may be counted independently (separately) for type #1′ DCI format and type #2′ DCI format. Accordingly, DAIs may be counted separately in the two sets. The number of the transmitted type #1′ DCI format and the number of the transmitted type #2′ DCI format may be separately determined based on the respective total DAIs in the CA case or respective counter DAIs in the single carrier case.

A unified number of HARQ-ACK information bits (hereinafter, denoted as “P” for clarity) may be generated for each type #2′ DCI format. For example, the unified number of HARQ-ACK information bits per second type DCI may be determined based on an explicit configuration or an implicit (or predefined) rule, so as to solve the problem of a missing type #2′ DCI format. For example, the unified number may be configured by a BS via RRC signaling. For example, the unified number may be predefined or determined according to the average value of the set of possible CBG numbers for a TB. The unified number may be 1, 2, 4, 6, or 8.

A UE may generate separate HARQ-ACK sub-codebooks (e.g., HARQ-ACK sub-codebook #1′ for set #1′ and HARQ-ACK sub-codebook #2′ for set #2′) for the two sets, which may be included in a final HARQ-ACK codebook for transmitting on the scheduled slot to the BS. For example, HARQ-ACK sub-codebook #1′ may include HARQ-ACK information bits with each bit corresponding to a respective type #1′ DCI format in set #1′. HARQ-ACK sub-codebook #2′ may include HARQ-ACK information bits with every P consecutive bits corresponding to a respective type #2′ DCI format in set #2′. HARQ-ACK sub-codebooks #1′ and #2′ may be arranged according to a predefined order in the HARQ-ACK codebook. For example, HARQ-ACK sub-codebook #1 may be placed in front of HARQ-ACK sub-codebook #2′.

In HARQ-ACK sub-codebook #1′, the HARQ-ACK information bits may be ordered according to the DAIs (e.g., counter DAIs) of DCI formats in set #1′ (e.g., an ascending or descending order of the DAIs). Each HARQ-ACK information bit in HARQ-ACK sub-codebook #1′ may correspond to a respective DCI format in set #1′. For example, a HARQ-ACK information bit in HARQ-ACK sub-codebook #1′ may be a single HARQ-ACK information bit for a PDSCH scheduled by a corresponding type #1′ DCI format, or a single HARQ-ACK information bit for a corresponding type #1′ DCI format which indicates an SPS release or SCell dormancy.

In some embodiments, HARQ-ACK bundling or HARQ-ACK padding may be performed among the HARQ-ACK information bits for a type #2′ DCI format. For example, the UE may generate HARQ-ACK information bits for a DCI format in set #2′ based on the decoding status. When the number of generated HARQ-ACK information bits is larger than the unified number P, the UE may perform HARQ-ACK bundling (e.g., logic AND operation) to align the generated HARQ-ACK information bits with the unified number P. When the number of the generated HARQ-ACK information bits for the DCI format is less than the unified number P, the UE may perform HARQ-ACK padding (e.g., appending a NACK bit(s)) to align the generated HARQ-ACK information bits with the unified number P. Hence, each type #2′ DCI format corresponds to P consecutive bits in HARQ-ACK sub-codebook #2′.

Referring back to FIG. 2A, in some embodiments of the present disclosure, assuming that CC 232 and CC 233 are configured with CBG-based (re)transmission and CC 231 is not configured with CBG-based (re)transmission, any DCI formats on CC 231 and any fallback DCI format on any of the configured CCs (e.g., CCs 231-233) may not include the indicator for indicating the number of CBGs or the number of HARQ-ACK information bits for the scheduled TB. For example, since DCI format 221 is a fallback DCI format, DCI format 221 does not indicate the indicator. Since CC 231 is not configured with CBG-based (re)transmission, DCI formats 211, 214, 217, and 220 do not indicate the indicator.

It is further assumed that the above indicators of DCI formats 213, 215, 216 and 218 respectively indicate a CBG number of 2, 4, 2, and 6 for the scheduled TBs, and DCI formats 212 and 219 indicate a CBG number of 1 for the scheduled TBs. DCI formats 211-221 are divided into two sets (e.g., set #A1′ and set #A2′). According to the above descriptions with respect to type #1′ DCI format and type #2′ DCI format and set #1′ and set #2′, set #A1′ includes seven type #1 DCI formats, that is, DCI formats 211, 214, 217, and 220 on CC 231, one fall DCI format (i.e., DCI format 221) on CC 232, and two DCI formats with one CBG for the scheduled TBs (i.e., DCI format 212 and DCI format 219) on CC 232 and CC 233. Set #A2 includes four type #2 DCI formats, that is, two DCI formats with more than one CBG for the scheduled TBs (i.e., DCI format 215 and DCI format 218) on CC 232 and another two DCI formats with more than one CBG for the scheduled TBs (i.e., DCI format 213 and DCI format 216) on CC 233.

Counter DAI and total DAI are separately counted within each set. For example, {counter DAI, total DAI} of DCI formats 211-221 may indicate {1, 2}, {2, 2}, {1, 1}, {3, 3}, {2, 3}, {3, 3}, {4, 5}, {4, 4}, {5, 5}, {6, 7}, {7, 7}, respectively.

Referring to FIG. 2B, two HARQ-ACK sub-codebooks (e.g., sub-codebooks 271 and 272) may be generated for set #A1′ and set #A2′, respectively.

Sub-codebooks 271 and 272 may be arranged according to a predefined order in a HARQ-ACK codebook, which may be transmitted on PUCCH 261.

Sub-codebook 271 includes HARQ-ACK information bits for DCI formats in set #A1′. For example, as shown in FIG. 2B, sub-codebook 271 may include seven HARQ-ACK information bits, each of which corresponds to a respective DCI format of set #A1′ (i.e., DCI formats 211, 212, 214, 217, 219, 220, and 221). The seven HARQ-ACK information bits may be ordered according to the counter DAIs of DCI formats 211, 212, 214, 217, 219, 220, and 221.

Sub-codebook 272 includes HARQ-ACK information bits for DCI formats (e.g., DCI formats 213, 215, 216 and 218) in set #A2′. For simplicity, it is assumed that the unified number P of HARQ-ACK bits per type #2′ DCI format is 4. Sub-codebook 272 includes 4×4=16 CBG-based HARQ-ACK information bits with every 4 consecutive bits corresponding to the TB scheduled by a respective one of the four type #2′ DCI formats in set #A2′.

For DCI format 218, since the number of HARQ-ACK information bits before bundling is 6 (i.e., the indicator in DCI format 218 indicates a CBG number of 8), HARQ-ACK bundling (e.g., logic AND operation) is performed among the 6 HARQ-ACK information bits to generate 4 bits. For example, the last three bits of the 6 bits may be bundled to one bundled bit and the first three bits of the 6 bits are kept. For DCI format 213 and DCI format 216, since the number of HARQ-ACK information bits before padding is 2 (i.e., the indicators in DCI format 213 and DCI format 216 indicate a CBG number of 2), HARQ-ACK padding is performed to align the 2 HARQ-ACK information bits to 4 bits. For example, 2 NACK bits may be appended to the 2 HARQ-ACK information bits to generate 4 bits. Hence, each type #2′ DCI format in set #A2′ corresponds to 4 consecutive bits in sub-codebook 272.

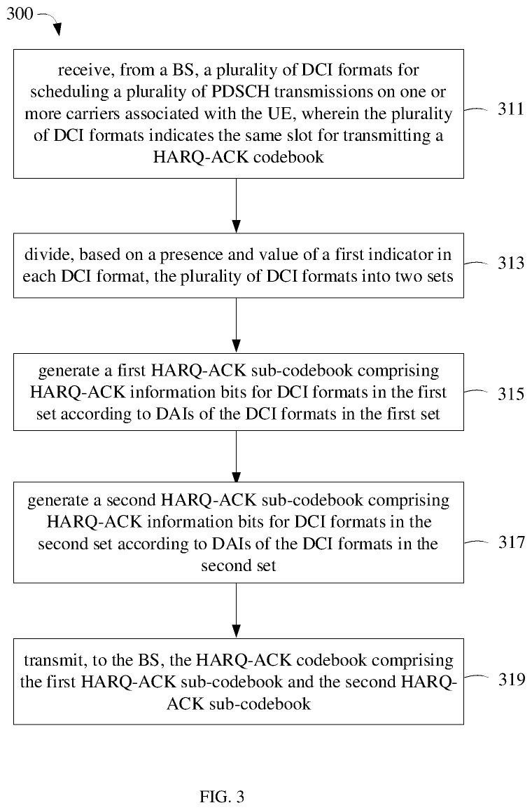

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a UE, for example, UE 101 in FIG. 1.

Referring to FIG. 3, in operation 311, a UE may receive, from a BS, a plurality of DCI formats for scheduling a plurality of PDSCH transmissions on one or more carriers associated with the UE. The plurality of DCI formats may indicate the same slot for transmitting a HARQ-ACK codebook. For example, referring back to FIG. 2B, the HARQ-ACK codebook may be transmitted on PUCCH 261.

In operation 313, the UE may divide, based on a presence and value of a first indicator in each DCI format, the plurality of DCI formats into two sets (e.g., set #A1 and set #A2 or set #A1′ and set #A2′ as described above). A first set (e.g., set #A1 or set #A1′) of the two sets may include all first type DCI formats (e.g., type #1 DCI format or type #1′ DCI format as described above) of the plurality of DCI formats. A second set (e.g., set #A2 or set #A2′) of the two sets may include all second type DCI formats (e.g., type #2 DCI format or type #2′ DCI format as described above) of the plurality of DCI formats. DAIs of the first type DCI formats are counted separately from those of the second type DCI formats.

In operation 315, the UE may generate a first HARQ-ACK sub-codebook including HARQ-ACK information bits for DCI formats in the first set according to DAIs of the DCI formats in the first set. In operation 317, the UE may generate a second HARQ-ACK sub-codebook including HARQ-ACK information bits for DCI formats in the second set according to DAIs of the DCI formats in the second set. In operation 319, the UE may transmit, to the BS, the HARQ-ACK codebook including the first HARQ-ACK sub-codebook and the second HARQ-ACK sub-codebook.

In some embodiments of the present disclosure, the first indicator may indicate whether CBG-based HARQ-ACK feedback is enabled or disabled. For example, the first indicator may be the CBGEI or TBEI as described above. In some examples, the first indicator is indicated by at least one bit in a DCI format of the plurality of DCI formats dedicated for enabling or disabling a CBG-based (re)transmission in response to the DCI format including the first indicator. In some examples, the CBGTI in a DCI format of the plurality of DCI formats is reused as the first indicator in response to the DCI format including the CBGTI.

The first type DCI format may be from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a disabled CBG-based (re)transmission. The second type DCI format may be a non-fallback DCI format with the first indicator indicating an enabled CBG-based (re)transmission.

In some embodiments, the second HARQ-ACK sub-codebook may include CBG-based HARQ-ACK information bits with every M consecutive bits corresponding to a respective DCI format in the second set, and M is the maximum number of CBGs per TB.

In some embodiments, the second HARQ-ACK sub-codebook may include a first part including TB-based HARQ-ACK feedback for TBs scheduled by DCI formats in the second set, and a second part including CBG-based HARQ-ACK feedback for a first TB among TB(s) scheduled by DCI formats in the second set and incorrectly decoded by the UE.

In some embodiments, the second HARQ-ACK sub-codebook may include a first part including TB-based HARQ-ACK feedback for TBs scheduled by DCI formats in the second set, and a second part including CBG-based HARQ-ACK feedback for first Z TBs among TB(s) scheduled by DCI formats in the second set and incorrectly decoded by the UE. In some examples, the value of Z may be configured by the BS. In some examples, the value of Z may be indicated by at least one of the plurality of DCI formats.

In some embodiments, the second HARQ-ACK sub-codebook may include: a first part including TB-based HARQ-ACK feedback for TBs scheduled by DCI formats in the second set, and a second part including CBG-based HARQ-ACK feedback for TB(s) scheduled by DCI formats in the second set and incorrectly decoded by the UE, wherein each bit of the second part corresponds to CBGs with the same CBG index among the TB(s) scheduled by DCI formats in the second set and incorrectly decoded by the UE. In the case that all TBs scheduled by DCI formats in the second set are correctly decoded by the UE, the second HARQ-ACK sub-codebook may include M padding bits, wherein M is the maximum number of CBGs per TB.

To generate the second HARQ-ACK sub-codebook, the UE may generate CBG-level HARQ-ACK information bits for the TB(s) scheduled by DCI formats in the second set and incorrectly decoded by the UE; perform HARQ-ACK bundling among the generated CBG-level HARQ-ACK information bits associated with the same CBG index to obtain a bundled bit; and in response to the number of bundled bits being smaller than a maximum number of CBGs per TB (e.g., M), perform HARQ-ACK padding to align the number of bundled bits with the maximum number of CBGs per TB.

In some embodiments, the second HARQ-ACK sub-codebook may include: a first part including TB-based HARQ-ACK feedback for TBs scheduled by DCI formats in the second set, and a second part including at least one bit field, wherein each of the at least one bit field corresponds to a respective TB of TB(s) scheduled by DCI formats in the second set and incorrectly decoded by the UE. In the case that all TBs scheduled by DCI formats in the second set are correctly decoded by the UE, the second HARQ-ACK sub-codebook may include M padding bits, wherein M is the maximum number of CBGs per TB.

To generate the second HARQ-ACK sub-codebook, the UE may generate a bit field by: generating CBG-level HARQ-ACK information bits for the respective TB; and in response to the generated CBG-level HARQ-ACK information bits being greater than a number of bits for a bit field, performing HARQ-ACK bundling to align the generated CBG-level HARQ-ACK information bits with the number of bits for a bit field.

The number of bits for a bit field may be based on a maximum number of CBGs per TB (e.g., M) and a number of TBs scheduled by DCI formats in the second set and incorrectly decoded by the UE.

In some embodiments of the present disclosure, the first indicator may indicate the number of CBGs or the number of HARQ-ACK information bits for a TB scheduled by a corresponding DCI.

The first type DCI format may be from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a single CBG per scheduled TB or a single HARQ-ACK information bit per scheduled TB. The second type DCI format may be a non-fallback DCI format with the first indicator indicating two or more CBGs per scheduled TB or two or more HARQ-ACK information bits per scheduled TB.

In some examples, each second type DCI format in the second set may correspond to a unified number (e.g., P) of HARQ-ACK information bits in the second HARQ-ACK sub-codebook.

In some examples, each HARQ-ACK information bit in the first HARQ-ACK sub-codebook may correspond to a respective DCI format in the first set, and every unified number of consecutive HARQ-ACK information bits in the second HARQ-ACK sub-codebook may correspond to a respective DCI format in the second set.

In some examples, to generate the second HARQ-ACK sub-codebook, the UE may: generate HARQ-ACK information bits for a DCI format in the second set; and in response to the number of the generated HARQ-ACK information bits for the DCI format being greater than the unified number, perform HARQ-ACK bundling to align the generated HARQ-ACK information bits with the unified number, or in response to the number of the generated HARQ-ACK information bits for the DCI format being less than the unified number, perform HARQ-ACK padding to align the generated HARQ-ACK information bits with the unified number.

In some examples, the unified number may be configured by the BS. In some examples, the unified number may be determined based on a predefined rule.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a BS, for example, BS 102 in FIG. 1.

Referring to FIG. 4, in operation 411, a BS may transmit, to a UE, a plurality of DCI formats for scheduling a plurality of PDSCH transmissions on one or more carriers associated with the UE. The plurality of DCI formats may indicate the same slot for transmitting a HARQ-ACK codebook.

The plurality of DCI formats may be divided into two sets (e.g., set #A1 and set #A2 or set #A1′ and set #A2′ as described above) based on a presence and value of a first indicator in each DCI forma. A first set (e.g., set #A1 or set #A1′) of the two sets may include all first type DCI formats (e.g., type #1 DCI format or type #1′ DCI format as described above) of the plurality of DCI formats. A second set (e.g., set #A2 or set #A2′) of the two sets may include all second type DCI formats (e.g., type #2 DCI format or type #2′ DCI format as described above) of the plurality of DCI formats. DAIs of the first type DCI formats are counted separately from those of the second type DCI formats.

In operation 413, the BS may, receive, from the UE, the HARQ-ACK codebook including a first HARQ-ACK sub-codebook and a second HARQ-ACK sub-codebook. The first HARQ-ACK sub-codebook may include HARQ-ACK information bits for DCI formats in the first set. The second HARQ-ACK sub-codebook may include HARQ-ACK information bits for DCI formats in the second set.

In some embodiments of the present disclosure, the first indicator may indicate whether CBG-based HARQ-ACK feedback is enabled or disabled. For example, the first indicator may be the CBGEI or TBEI as described above. In some examples, the first indicator is indicated by at least one bit in a DCI format of the plurality of DCI formats dedicated for enabling or disabling a CBG-based (re)transmission in response to the DCI format including the first indicator. In some examples, the CBGTI in a DCI format of the plurality of DCI formats is reused as the first indicator in response to the DCI format including the CBGTI.

The first type DCI format may be from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a disabled CBG-based (re)transmission. The second type DCI format may be a non-fallback DCI format with the first indicator indicating an enabled CBG-based (re)transmission.

In some embodiments, the second HARQ-ACK sub-codebook may include CBG-based HARQ-ACK information bits with every M consecutive bits corresponding to a respective DCI format in the second set, and M is the maximum number of CBGs per TB.

In some embodiments, the second HARQ-ACK sub-codebook may include a first part including TB-based HARQ-ACK feedback for TBs scheduled by DCI formats in the second set, and a second part including CBG-based HARQ-ACK feedback for a first TB among TB(s) scheduled by DCI formats in the second set and incorrectly decoded by the UE.

In some embodiments, the second HARQ-ACK sub-codebook may include a first part including TB-based HARQ-ACK feedback for TBs scheduled by DCI formats in the second set, and a second part including CBG-based HARQ-ACK feedback for first Z TBs among TB(s) scheduled by DCI formats in the second set and incorrectly decoded by the UE. In some examples, the BS may transmit the value of Z to the UE. In some examples, the value of Z may be indicated by at least one of the plurality of DCI formats.

In some embodiments, the second HARQ-ACK sub-codebook may include: a first part including TB-based HARQ-ACK feedback for TBs scheduled by DCI formats in the second set, and a second part including CBG-based HARQ-ACK feedback for TB(s) scheduled by DCI formats in the second set and incorrectly decoded by the UE, wherein each bit of the second part corresponds to CBGs with the same CBG index among the TB(s) scheduled by DCI formats in the second set and incorrectly decoded by the UE. In the case that all TBs scheduled by DCI formats in the second set are correctly decoded by the UE, the second HARQ-ACK sub-codebook may include M padding bits, wherein M is the maximum number of CBGs per TB.

In some embodiments, the second HARQ-ACK sub-codebook may include: a first part including TB-based HARQ-ACK feedback for TBs scheduled by DCI formats in the second set, and a second part including at least one bit field, wherein each of the at least one bit field corresponds to a respective TB of TB(s) scheduled by DCI formats in the second set and incorrectly decoded by the UE. In the case that all TBs scheduled by DCI formats in the second set are correctly decoded by the UE, the second HARQ-ACK sub-codebook may include M padding bits, wherein M is the maximum number of CBGs per TB. In some examples, the number of bits for a bit field may be based on a maximum number of CBGs per TB (e.g., M) and a number of TBs scheduled by DCI formats in the second set and incorrectly decoded by the UE.

In some embodiments of the present disclosure, the first indicator may indicate the number of CBGs or the number of HARQ-ACK information bits for a TB scheduled by a corresponding DCI.

The first type DCI format may be from a group including one or more of the following: a fallback DCI format; a non-fallback DCI format transmitted on a carrier not configured with a CBG-based (re)transmission; a non-fallback DCI format without presence of the first indicator; or a non-fallback DCI format with the first indicator indicating a single CBG per scheduled TB or a single HARQ-ACK information bit per scheduled TB. The second type DCI format may be a non-fallback DCI format with the first indicator indicating two or more CBGs per scheduled TB or two or more HARQ-ACK information bits per scheduled TB.

In some examples, each second type DCI format in the second set may correspond to a unified number (e.g., P) of HARQ-ACK information bits in the second HARQ-ACK sub-codebook.

In some examples, each HARQ-ACK information bit in the first HARQ-ACK sub-codebook may correspond to a respective DCI format in the first set, and every unified number of consecutive HARQ-ACK information bits in the second HARQ-ACK sub-codebook may correspond to a respective DCI format in the second set.

In some examples, the BS may transmit the unified number to the UE. In some examples, the unified number may be determined based on a predefined rule.

It should be appreciated by persons skilled in the art that the sequence of the operations in exemplary procedure 400 may be changed and some of the operations in exemplary procedure 400 may be eliminated or modified, without departing from the spirit and scope of the disclosure.

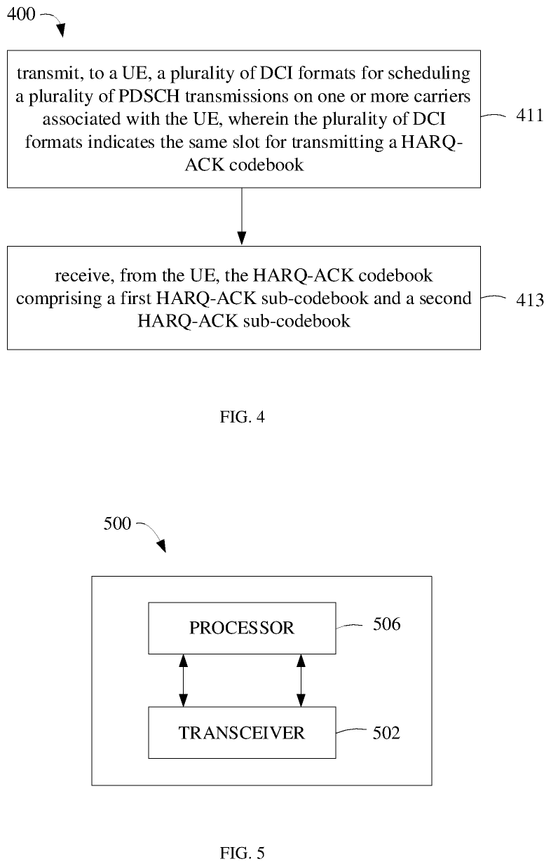

FIG. 5 illustrates a block diagram of an exemplary apparatus 500 according to some embodiments of the present disclosure. As shown in FIG. 5, the apparatus 500 may include at least one processor 506 and at least one transceiver 502 coupled to the processor 506. The apparatus 500 may be a UE or a BS.

Although in this figure, elements such as the at least one transceiver 502 and processor 506 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE. The transceiver 502 and the processor 506 may interact with each other so as to perform the operations with respect to the UE described in FIGS. 1-4. In some embodiments of the present application, the apparatus 500 may be a BS. The transceiver 502 and the processor 506 may interact with each other so as to perform the operations with respect to the BS described in FIGS. 1-4.

In some embodiments of the present application, the apparatus 500 may further include at least one non-transitory computer-readable medium.

For example, in some embodiments of the present disclosure, the non-transitory computer-readable medium may have stored thereon computer-executable instructions to cause the processor 506 to implement the method with respect to the UE as described above. For example, the computer-executable instructions, when executed, cause the processor 506 interacting with transceiver 502 to perform the operations with respect to the UE described in FIGS. 1-4.

In some embodiments of the present disclosure, the non-transitory computer-readable medium may have stored thereon computer-executable instructions to cause the processor 506 to implement the method with respect to the BS as described above. For example, the computer-executable instructions, when executed, cause the processor 506 interacting with transceiver 502 to perform the operations with respect to the BS described in FIGS. 1-4.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a base station (BS), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook;
divide, based on a presence and value of a first indicator in each DCI format, the plurality of DCI formats into two sets, wherein a first set of the two sets comprises all first type DCI formats of the plurality of DCI formats and a second set of the two sets comprises all second type DCI formats of the plurality of DCI formats, wherein downlink assignment indicators (DAIs) of the first type DCI formats are counted separately from those of the second type DCI formats;
generate a first HARQ-ACK sub-codebook comprising HARQ-ACK information bits for DCI formats in the first set according to the DAIs of the DCI formats in the first set;
generate a second HARQ-ACK sub-codebook comprising HARQ-ACK information bits for DCI formats in the second set according to the DAIs of the DCI formats in the second set; and
transmit, to the BS, the HARQ-ACK codebook comprising the first HARQ-ACK sub-codebook and the second HARQ-ACK sub-codebook.

2. The UE of claim 1, wherein the first indicator indicates whether code block group (CBG)-based HARQ-ACK feedback is enabled or disabled.

3. The UE of claim 2, wherein the first type DCI format is from a group including one or more of:
a fallback DCI format;
a non-fallback DCI format transmitted on a carrier not configured with a CBG-based (re)transmission;
a non-fallback DCI format without presence of the first indicator; or
a non-fallback DCI format with the first indicator indicating a disabled CBG-based (re)transmission; and
wherein the second type DCI format is a non-fallback DCI format with the first indicator indicating an enabled CBG-based (re)transmission.

4. The UE of claim 2, wherein the second HARQ-ACK sub-codebook comprises CBG-based HARQ-ACK information bits with every M consecutive bits corresponding to a respective DCI format in the second set, and M is a maximum number of CBGs per transport block (TB); or
wherein the second HARQ-ACK sub-codebook comprises a first part comprising TB-based HARQ-ACK feedback for TBs scheduled by DCI formats in the second set, and a second part comprising one of:
CBG-based HARQ-ACK feedback for a first TB among TB(s) scheduled by DCI formats in the second set and incorrectly decoded by the UE; or
CBG-based HARQ-ACK feedback for first Z TBs among TB(s) scheduled by DCI formats in the second set and incorrectly decoded by the UE, wherein a value of Z is configured by the BS or is indicated by at least one of the plurality of DCI formats.

5. The UE of claim 2, wherein the second HARQ-ACK sub-codebook comprises:
a first part comprising transport block (TB)-based HARQ-ACK feedback for TBs scheduled by DCI formats in the second set; and
a second part comprising CBG-based HARQ-ACK feedback for one or more TBs scheduled by DCI formats in the second set and incorrectly decoded by the UE, wherein each bit of the second part corresponds to CBGs with a same CBG index among the one or more TBs scheduled by DCI formats in the second set and incorrectly decoded by the UE.

6. The UE of claim 5, wherein to generate the second HARQ-ACK sub-codebook, the at least one processor is configured to cause the UE to:
generate CBG-level HARQ-ACK information bits for the one or more TBs scheduled by DCI formats in the second set and incorrectly decoded by the UE;
perform HARQ-ACK bundling among the generated CBG-level HARQ-ACK information bits associated with the same CBG index to obtain a bundled bit; and
in response to a number of bundled bits being smaller than a maximum number of CBGs per TB, perform HARQ-ACK padding to align the number of bundled bits with the maximum number of CBGs per TB.

7. The UE of claim 2, wherein the second HARQ-ACK sub-codebook comprises:
a first part comprising transport block (TB)-based HARQ-ACK feedback for one or more TBs scheduled by the DCI formats in the second set; and
a second part comprising at least one bit field, wherein each of the at least one bit field corresponds to a respective TB of the one or more TBs scheduled by the DCI formats in the second set and incorrectly decoded by the UE.

8. The UE of claim 7, wherein to generate the second HARQ-ACK sub-codebook, the at least one processor is configured to cause the UE to generate a bit field by:
generating CBG-level HARQ-ACK information bits for the respective TB; and
in response to the generated CBG-level HARQ-ACK information bits being greater than a number of bits for a bit field, performing HARQ-ACK bundling to align the generated CBG-level HARQ-ACK information bits with the number of bits for the bit field.

9. The UE of claim 8, wherein a number of bits for the bit field is based on a maximum number of CBGs per transport block (TB) and a number of TBs scheduled by the DCI formats in the second set and incorrectly decoded by the UE.

10. The UE of claim 1, wherein the first indicator indicates a number of code block groups (CBGs) or a number of HARQ-ACK information bits for a TB scheduled by a corresponding DCI.

11. The UE of claim 10, wherein the first type DCI format is from a group including one or more of:
a fallback DCI format;
a non-fallback DCI format transmitted on a carrier not configured with a CBG-based (re)transmission;
a non-fallback DCI format without a presence of the first indicator; or
a non-fallback DCI format with the first indicator indicating a single CBG per scheduled TB or a single HARQ-ACK information bit per scheduled TB; and
wherein the second type DCI format is a non-fallback DCI format with the first indicator indicating two or more CBGs per scheduled TB or two or more HARQ-ACK information bits per scheduled TB.

12. The UE of claim 10, wherein each second type DCI format in the second set corresponds to a unified number of HARQ-ACK information bits in the second HARQ-ACK sub-codebook.

13. The UE of claim 10, wherein each HARQ-ACK information bit in the first HARQ-ACK sub-codebook corresponds to a respective DCI format in the first set, and every unified number of consecutive HARQ-ACK information bits in the second HARQ-ACK sub-codebook corresponds to a respective DCI format in the second set.

14. A base station (BS) for wireless communication, comprising:
at least one memory; and
at least one processor coupled with the at least one memory and configured to cause the BS to:
transmit, to a user equipment (UE), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook; and
receive, from the UE, the HARQ-ACK codebook comprising a first HARQ-ACK sub-codebook and a second HARQ-ACK sub-codebook, wherein:
the plurality of DCI formats is divided into two sets based on a presence and value of a first indicator in each DCI format, wherein a first set of the two sets comprises all first type DCI formats of the plurality of DCI formats and a second set of the two sets comprises all second type DCI formats of the plurality of DCI formats, and wherein downlink assignment indicators (DAIs) of the first type DCI formats are counted separately from those of the second type DCI formats;
the first HARQ-ACK sub-codebook comprises HARQ-ACK information bits for DCI formats in the first set; and
the second HARQ-ACK sub-codebook comprises HARQ-ACK information bits for DCI formats in the second set.

15. A method performed by a user equipment (UE), the method comprising:
receiving, from a base station (BS), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook;
dividing, based on a presence and value of a first indicator in each DCI format, the plurality of DCI formats into two sets, wherein a first set of the two sets comprises all first type DCI formats of the plurality of DCI formats and a second set of the two sets comprises all second type DCI formats of the plurality of DCI formats, wherein downlink assignment indicators (DAIs) of the first type DCI formats are counted separately from those of the second type DCI formats;
generating a first HARQ-ACK sub-codebook comprising HARQ-ACK information bits for DCI formats in the first set according to the DAIs of the DCI formats in the first set;
generating a second HARQ-ACK sub-codebook comprising HARQ-ACK information bits for DCI formats in the second set according to the DAIs of the DCI formats in the second set; and
transmitting, to the BS, the HARQ-ACK codebook comprising the first HARQ-ACK sub-codebook and the second HARQ-ACK sub-codebook.

16. A processor for wireless communication, comprising:
at least one controller coupled with at least one memory and configured to cause the processor to:
receive, from a base station (BS), a plurality of downlink control information (DCI) formats for scheduling a plurality of physical downlink shared channel (PDSCH) transmissions on one or more carriers associated with the UE, wherein the plurality of DCI formats indicates a same slot for transmitting a hybrid automatic repeat request acknowledge (HARQ-ACK) codebook;
divide, based on a presence and value of a first indicator in each DCI format, the plurality of DCI formats into two sets, wherein a first set of the two sets comprises all first type DCI formats of the plurality of DCI formats and a second set of the two sets comprises all second type DCI formats of the plurality of DCI formats, wherein downlink assignment indicators (DAIs) of the first type DCI formats are counted separately from those of the second type DCI formats;
generate a first HARQ-ACK sub-codebook comprising HARQ-ACK information bits for DCI formats in the first set according to the DAIs of the DCI formats in the first set;
generate a second HARQ-ACK sub-codebook comprising HARQ-ACK information bits for DCI formats in the second set according to the DAIs of the DCI formats in the second set; and
transmit, to the BS, the HARQ-ACK codebook comprising the first HARQ-ACK sub-codebook and the second HARQ-ACK sub-codebook.

17. The processor of claim 16, wherein the first indicator indicates whether code block group (CBG)-based HARQ-ACK feedback is enabled or disabled.

18. The processor of claim 17, wherein the first type DCI format is from a group including one or more of:
a fallback DCI format;
a non-fallback DCI format transmitted on a carrier not configured with a CBG-based (re)transmission;
a non-fallback DCI format without presence of the first indicator; or
a non-fallback DCI format with the first indicator indicating a disabled CBG-based (re)transmission; and
wherein the second type DCI format is a non-fallback DCI format with the first indicator indicating an enabled CBG-based (re)transmission.

19. The processor of claim 17, wherein the second HARQ-ACK sub-codebook comprises CBG-based HARQ-ACK information bits with every M consecutive bits corresponding to a respective DCI format in the second set, and M is a maximum number of CBGs per transport block (TB); or
wherein the second HARQ-ACK sub-codebook comprises a first part comprising TB-based HARQ-ACK feedback for TBs scheduled by DCI formats in the second set, and a second part comprising one of:
CBG-based HARQ-ACK feedback for a first TB among TB(s) scheduled by DCI formats in the second set and incorrectly decoded by the UE; or
CBG-based HARQ-ACK feedback for first Z TBs among TB(s) scheduled by DCI formats in the second set and incorrectly decoded by the UE, wherein a value of Z is configured by the BS or is indicated by at least one of the plurality of DCI formats.

20. The processor of claim 17, wherein the second HARQ-ACK sub-codebook comprises:
a first part comprising transport block (TB)-based HARQ-ACK feedback for TBs scheduled by DCI formats in the second set; and
a second part comprising CBG-based HARQ-ACK feedback for one or more TBs scheduled by DCI formats in the second set and incorrectly decoded by the UE, wherein each bit of the second part corresponds to CBGs with a same CBG index among the one or more TBs scheduled by DCI formats in the second set and incorrectly decoded by the UE.
